(19) United States
(12) Patent Application Publication
(10) Pub. No.: US 2010/0122338 A1
(43) Pub. Date: May 13, 2010

(54) NETWORK SYSTEM, DHCP SERVER DEVICE, AND DHCP CLIENT DEVICE

(75) Inventors: Mikio KATAOKA, Tachikawa (JP); Hidenori Inouchi, Higashimurayama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(73) Assignee: Hitachi, Ltd.

(21) Appl. No.: 12/615,452

(22) Filed: Nov. 10, 2009

(30) Foreign Application Priority Data
Nov. 11, 2008 (JP) 2008-288878

(51) Int. Cl. G06F 15/177; H04L 9/32; H04L 9/08; G06F 21/00

(52) U.S. Cl. 726/12; 709/222; 713/168; 380/278; 726/15

(57) ABSTRACT

When customer-premises communication equipment connected to a home gateway device is about to establish IP communication with a server on a network, the present invention enables the server to establish communication after verifying that the physical connection location of the communication equipment is authorized. When a DHCP server issues an IP address to the home gateway device, the DHCP server not only passes a circuit-ID-based identifier to the home gateway device, but also transmits the identifier and information about the home gateway device to the server. Upon receipt of the identifier through the home gateway device, a communication equipment requests to establish IP communication with the server by using the identifier and the information about the home gateway device to which the communication equipment is connected. This permits the server to check whether the connection path of the communication equipment that has requested to be connected is proper.

### CLAIM OF PRIORITY

The present application claims priority from Japanese patent application JP2008-288878 filed on Nov. 11, 2008, the content of which is hereby incorporated by reference into this application.

### BACKGROUND OF THE INVENTION

(1) Field of the Invention

The present invention relates to an authentication technology for a DHCP (Dynamic Host Configuration Protocol) client-server system.

(2) Description of the Related Art

For devices communicating with each other on a conventional IP (Internet Protocol) layer, the concept of physical device locations does not exist, but a network is configured by connecting the devices logically.

In recent years, it is expected that the no-service area of a cell phone will be eliminated or reduced by installing a small-size cell phone base station (femtocell base station) in each home and connecting it to a cellular carrier network (NW) through the Internet. It is also expected that the investment burden on a cellular carrier, for example, will be reduced by offloading its traffic through the Internet by making use of a carrier network.

Further, a home gateway device will be introduced to establish a connection between a home and a carrier network. The home gateway device is obtained by enhancing the functions of a conventional broadband router to provide improved security functions and communication control functions. When a femtocell base station device is installed in a home, it is connected to a cellular carrier network through the home gateway device. Alternatively, femtocell base station functions may be implemented as a module for the home gateway device.

When the femtocell base station device is to be installed, it is essential that it be used only at a specified location to avoid radio wave interference and illegal use. To avoid such problems, it is necessary to specify the location of connection to a femtocell base station and authenticate the path of such a connection.

The “authentication method” disclosed in Japanese Patent Application Laid-Open Publication No. 2007-172053 achieves user authentication by sending personal authentication information, which a client terminal has obtained from an application server on an IP network, to the application server through a cell phone network by using a cell phone terminal.

### BRIEF SUMMARY OF THE INVENTION

According to Japanese Patent Application Laid-Open publication No. 2007-172053, a client terminal connection location can be identified when location information about a cell phone terminal is transmitted to an application server through a cellular network. However, it is practically difficult to achieve location identification with accuracy because the cell phone terminal may move away from the client terminal after acquisition of authentication information. Further, it is necessary to use an additional network other than an IP network. It is therefore conceivable that the use of a complicated system may cause a cost increase and other problems.

When a femtocell base station device is connected to a cellular carrier network through the Internet by using an FTTH (Fiber To The Home), ADSL (Asymmetric Digital Subscriber Line), or other broadband network, the location of the femtocell base station device cannot be identified by an IP address alone. Further, it is possible that the femtocell base station device may be illegally used at a location other than those predetermined by a cellular carrier, for instance, through the use of a fake IP address. As the physical location of the femtocell base station device cannot be fixed, may be used by an unexpected user. This may result in extra billing for authorized users or may lead to the commitment of a crime, for instance, through a theft or trading between users.

It is necessary to provide a secure communication path between a femtocell base station device and a femtocell base station gateway (GW). However, it is difficult for users to complete a necessary communication path setup procedure by themselves. Further, when fixed information preset in the femtocell base station device is used to establish the secure communication path, it may easily be misused once it is leaked to a malicious user.

It is an object of the present invention to provide a network system, a DHCP server device, and a DHCP client device that are capable of establishing communication after verifying that the physical connection location of customer-premises communication equipment connected to the home gateway device is authorized in a situation where the customer-premises communication equipment is about to communicate with an application server device on a network in accordance with an IP.

In accomplishing the above object, according to one aspect of the present invention, there is provided a network system in which a DHCP server device, a DHCP client device, and an application server device are connected through a network. The DHCP server device includes a storage section for storing individual identification information about the DHCP client device and connection path information about the connection of the DHCP client device as a pair. When issuing an IP address to the DHCP client device, the DHCP server device compares individual identification information and DHCP client device connection path information received from the DHCP client device against the information stored in the storage section. Only when the compared items of information match, the DHCP server device transmits the IP address and an identifier generated from the connection path information to the DHCP client device, and transmits the identifier and the individual identification information about the DHCP client device to the application server device. The DHCP client device transmits the identifier and individual identification information received from the DHCP server device to the application server device when establishing a communication path to the application server device. The application server device compares the identifier and individual identification information transmitted from the DHCP client device against the identifier and individual identification information transmitted from the DHCP server device, and establishes the communication path to the DHCP client device only when the compared items of information match.

In accomplishing the above object, according to another aspect of the present invention, there is provided a network system including a DHCP server device, a DHCP client device, an application server device, and a communication device that uses the DHCP client device as a gateway to connect to a network. The DHCP server device includes a storage section for storing individual identification information about the DHCP client device and connection path information about the connection of the DHCP client device. When issuing an IP address to the DHCP client device, the DHCP server device compares individual identification information and DHCP client device connection path information received from the DHCP client device against the information stored in the storage section. Only when the compared items of information match, the DHCP server device transmits the IP address and an identifier generated from the connection path information to the DHCP client device, and transmits the identifier and the individual identification information about the DHCP client device to the application server device. The DHCP client device checks identification information about the communication device when the communication device makes a request for the issuance of the IP address. When the identification information about the communication device indicates that the identifier and individual identification information about the DHCP client device need to be transmitted, the DHCP client device issues the IP address with the identifier and individual identification information about the DHCP client device attached to it. When the communication device establishes a communication path to the application server device, the DHCP client device transmits the identifier and individual identification information about the DHCP client device to the application server device. The application server device compares the identifier and DHCP client device individual identification information transmitted from the DHCP client device against the identifier and DHCP client device individual identification information transmitted from the DHCP server device, and establishes a communication path to the communication device only when the compared items of information match.

According to a preferred configuration of the present invention, a circuit ID, which is connection path information attached to an IP address issued from a DHCP server device to a home gateway device, that is, a DHCP client device having femtocell base station functions or connected to a femtocell base station device serving as a communication device, is used to identify the physical location of a femtocell base station. When the DHCP server device issues the IP address to the home gateway device, the DHCP server device not only passes an identifier based on the circuit ID to the home gateway device, but also transmits the same identifier to a femtocell base station gateway, which is an application server device. When the identifier is used to establish a communication path between the home gateway device and femtocell base station gateway, the femtocell base station gateway can verify that access is gained from the femtocell base station at an authorized user's residence.

Further, when an identifier for femtocell circuit authentication is used as a shared encryption key for communication path establishment between the femtocell base station and femtocell base station gateway, a secure communication path can be obtained without requiring any prior setup by a user.

The present invention can achieve circuit authentication for devices engaged in communication on an IP layer. Moreover, when an identifier for circuit authentication is used as an encryption key, the present invention makes it possible to establish a secure communication path between devices.

### BRIEF DESCRIPTION OF THE DRAWINGS

FIG. 1 is a diagram illustrating the configuration of a network system according to a first embodiment of the present invention;

FIG. 2 is a diagram illustrating the configuration of a home gateway device that incorporates femtocell base station functions according to the first embodiment;

FIG. 3 is a sequence diagram illustrating how a DHCP server according to the first embodiment issues an IP address to the home gateway device;

FIG. 4 is a flowchart illustrating how the home gateway device operates when the DHCP server according to the first embodiment issues an IP address to the home gateway device;

FIG. 5 is a flowchart illustrating how the DHCP server according to the first embodiment operates when it issues an IP address to the home gateway device;

FIG. 6 is a diagram illustrating an exemplary configuration of a home gateway device information table according to the first embodiment;

FIG. 7 is a diagram illustrating an exemplary configuration of a femtocell base station information table according to the first embodiment;

FIG. 8 is a sequence diagram illustrating how a femtocell base station module according to the first embodiment registers itself at a femtocell base station gateway;

FIG. 9 is a diagram illustrating the configuration of a network system according to a second embodiment of the present invention;

FIG. 10 is a diagram illustrating an exemplary configuration formed when a femtocell base station device according to the second embodiment is different from a home gateway device;

FIG. 11 is a sequence diagram illustrating how the home gateway device issues an IP address to the femtocell base station device according to the second embodiment;

FIG. 12 is a flowchart illustrating how the home gateway device according to the second embodiment operates when it issues an IP address to the femtocell base station device;

FIG. 13 is a sequence diagram illustrating how the femtocell base station device according to the second embodiment registers itself at a femtocell base station gateway;

FIG. 14A is a diagram that relates to both embodiments and illustrates an exemplary configuration of a DHCP packet to which a circuit ID is attached;

FIG. 14B is a diagram that relates to both embodiments and illustrates an exemplary configuration of a DHCP packet to which a circuit ID is attached; and

FIG. 14C is a diagram that relates to both embodiments and illustrates an exemplary configuration of a DHCP packet to which a circuit ID is attached.

### DETAILED DESCRIPTION OF THE INVENTION

Embodiments of the present invention will now be described with reference to the accompanying drawings. The following description assumes that the present invention is configured to use a home gateway device and a femtocell base station gateway as a DHCP client device and an application server device, respectively. However, the present invention is not limited to such a configuration.

### First Embodiment

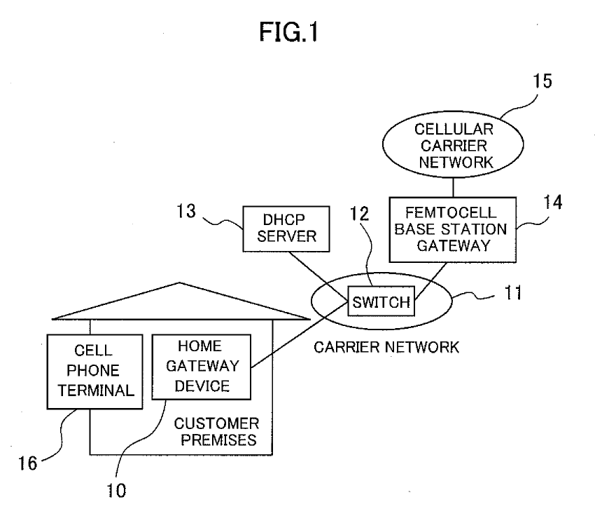

A system according to a first embodiment of the present invention will now be described with reference to FIGS. 1 to 8 and FIGS. 14A to 14C. The first embodiment will be described by explaining about session establishment between a femtocell base station, which incorporates both home gateway functions and femtocell base station functions, and an application server, which offers specific femtocell base station gateway functions.

FIG. 1 is a diagram illustrating the configuration of the system according to the present embodiment. A home gateway device 10 is positioned between a customer-premises network and a carrier network 11 to mediate communication between customer-premises communication equipment and an external network. The home gateway device 10 is connected to a DHCP server 13 through a switch 12 within the carrier network 11. An IP address is delivered to the home gateway device 10 upon request from the home gateway device 10. Here, it is assumed that the switch 12 incorporates a DHCP relay function with a DHCP relay agent information option (option code: 82) enabled. Although FIG. 1 shows only one switch 12, the connection to the DHCP server 13 may be established through two or more switches 12.

The DHCP server 13 stores, in advance, paired information that includes an individual ID of a home gateway device 10 and a circuit ID of a circuit to which the home gateway device 10 is connected. Before issuing an IP address to the home gateway device 10, the DHCP server 13 checks for a match between the individual ID and circuit ID to determine whether the home gateway device 10 is used at an authorized user's residence.

Femtocell base station functions are incorporated in the home gateway device 10 according to the present embodiment. After an IP address is assigned to the home gateway device 10 from the DHCP server 13, a secure communication session is established between the home gateway device 10 and a femtocell base station gateway 14, which serves as an application server positioned between a carrier network 11 and a cellular carrier network 15. A customer-premises cell phone terminal 16 can communicate with another cell phone terminal as it is connected to the cellular carrier network 15 through a femtocell base station, which is incorporated in the home gateway device 10, and through the femtocell base station gateway 14.

The configurations of the DHCP server 13 and the femtocell base station gateway 14, which is an application server offering a particular function, are not specifically described here. However, it is obvious that they include, for instance, a normal CPU (Central Processing Unit) functioning as a processing section, a storage section, a network interface, and an input/output section that are included in a normal server configuration or computer system and interconnected through an internal bus or the like.

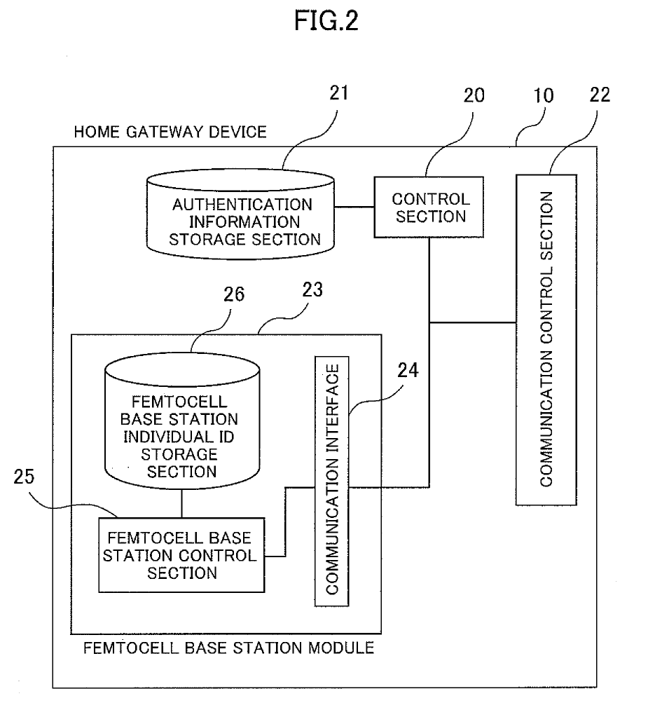

The configuration of the home gateway device 10 is shown in FIG. 2. The home gateway device 10 includes a communication control section 22 for communicating with a customer-premises network and carrier network 11. Packets received by the home gateway device 10 are processed by the communication control section 22 and forwarded as needed to the other devices. Packets requiring further processing are transmitted to a control section 20 and processed in the control section 20. The control section 20 is a normal CPU. An authentication information storage section 21 stores the individual ID of the home gateway device 10 and other information necessary for the DHCP server 13 to authenticate the home gateway device 10. When the home gateway device 10 requests the DHCP server 13 to issue an IP address, the information stored in the authentication information storage section 21 is read, attached to a request packet, and transmitted.

The home gateway device 10 includes a femtocell base station module 23, which communicates with the home gateway device 10 and the outside through a communication interface 24. The femtocell base station module 23 is controlled by a femtocell base station control section 25. A storage section 26 stores the individual ID of a femtocell base station represented by the module 23. This ID is used to register the femtocell base station at the femtocell base station gateway 14. It is assumed that this ID is set to a fixed value prior to shipment and cannot be read or rewritten by a user.

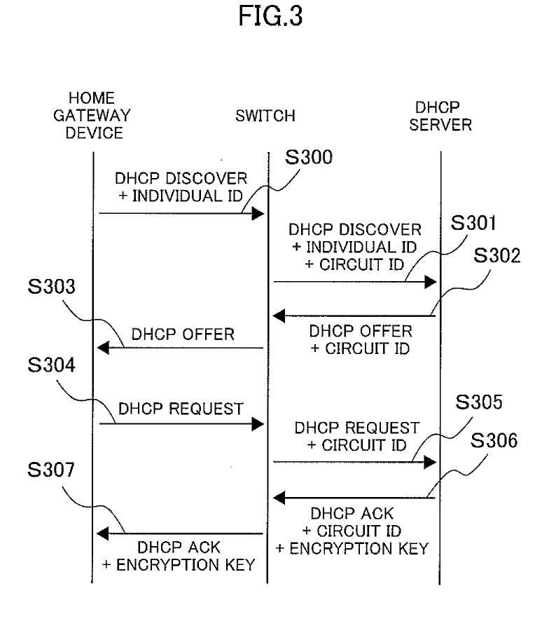

FIG. 3 is a sequence diagram illustrating how an IP address is assigned to the home gateway device 10. Upon startup, the home gateway device 10 transmits a DHCP DISCOVER packet (step S300) to acquire an IP address. In this instance, an individual ID for identifying the home gateway device 10 is acquired from the authentication information storage section 21 and attached to the DHCP DISCOVER packet.

The DHCP DISCOVER packet is transferred to the DHCP server 13 through the switch 12 (step S301). In this instance, the switch 12 attaches a circuit ID to the DHCP DISCOVER packet for allowing the DHCP server 13 to send a response packet to the home gateway device 10. The circuit ID is composed of a MAC address and a port number of the switch 12. Alternatively, the circuit ID may be an identifier preselected for the switch 12.

Upon receipt of the DHCP DISCOVER packet from the home gateway device 10, the DHCP server 13 compares the packeted individual ID and circuit ID of the home gateway device 10 against the previously stored individual ID and circuit ID of the home gateway device 10 to check whether the home gateway device 10 is authorized and connected from an authorized location. If the result of the comparison indicates that there is no problem, the DHCP server 13 determines the IP address to be delivered to the home gateway device 10 and sends it as a DHCP OFFER packet to the home gateway device 10 (step S302). The circuit ID, which was attached by the switch, remains attached to the DHCP OFFER packet and is used to send the packet to the home gateway device 10. When the packet passes through the switch 12, the switch 12 deletes the circuit ID, which was attached by the switch 12, and then transfers the packet (step S303).

Upon receipt of the DHCP OFFER packet, the home gateway device 10 checks whether the IP address assigned by the DHCP server 13 is usable. If there is no problem, the home gateway device 10 transmits a DHCP REQUEST packet to the DHCP server 13 (steps S304 and S305).

Upon receipt of the DHCP REQUEST packet, the DHCP server 13 generates an encryption key from the circuit ID contained in the packet, attaches the generated encryption key to a DHCP ACK packet, and sends the DHCP ACK packet to the home gateway device 10 (steps S306 and S307).

Upon receipt of the DHCP ACK packet, the home gateway device 10 obtains the encryption key from the received DHCP ACK packet (the encryption key was attached by the DHCP server 13), and stores the encryption key in itself 10.

The above-described operation enables the home gateway device 10 to acquire the encryption key necessary for accessing the femtocell base station gateway 14, which is an application server, at the instant at which the DHCP server 13 issues an address.

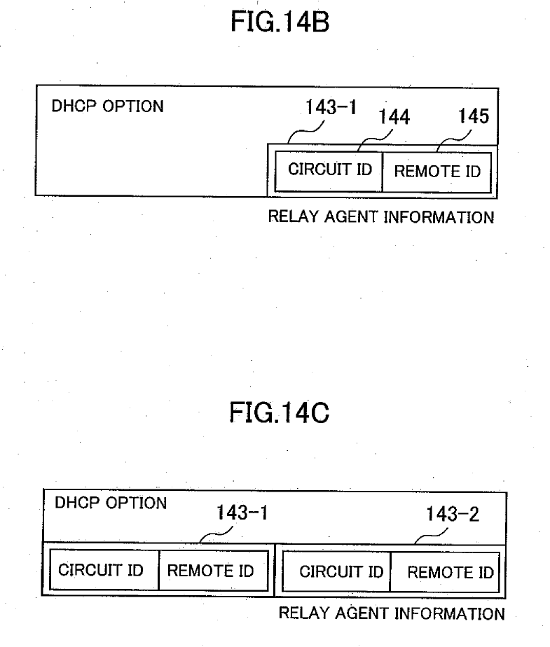

FIGS. 14A to 14C show exemplary configurations of a DROP packet to which a circuit ID is attached. The circuit ID is included in an option field of the DHCP packet (FIG. 14A). It is attached to the end of the DHCP option field as relay agent information 143. The relay agent information 143 includes, for instance, a circuit ID 144 for identifying the requesting circuit of a device and a remote ID 144 for identifying the device (FIG. 14B). The relay agent information 143 is attached to the end of the DHCP option field each time the packet passes through the switch 12 (FIG. 14C).

An aggregate of the above relay agent information attached to the DHCP packet is unique to each connection path. The DHCP server 13 acquires the aggregate of the relay agent information from the option field of the DHCP packet and creates an encryption key, such as a WEP (Wired Equivalent Privacy) key or AES (Advanced Encryption Standard) key, by using the acquired aggregate of the relay agent information as a key. Alternatively, any uniquely-defined encryption key may be created.

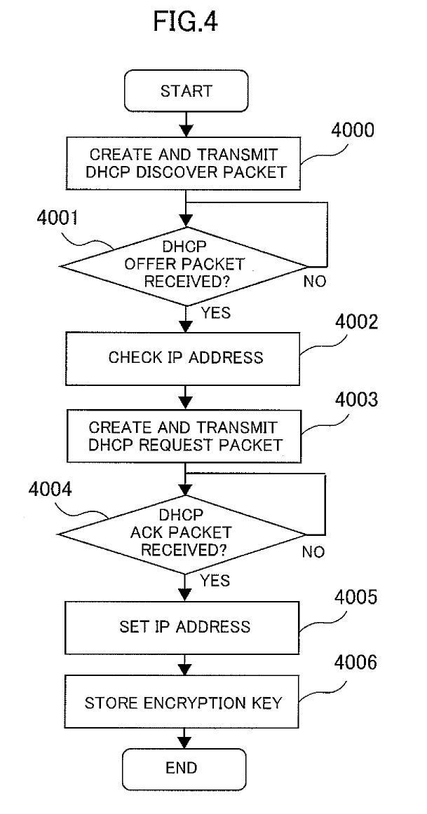

FIG. 4 is a flowchart illustrating a process in which the home gateway device 10 acquires an IP address from the DHCP server 13. This process is performed by a CPU that serves as the aforementioned control section. Upon startup, the home gateway device 10 creates a DHCP DISCOVER packet to acquire an IP address from the DHCP server 13. In this instance, an individual ID for identifying the home gateway device 10 is attached to a DHCP DISCOVER message. The created DHCP DISCOVER packet is transmitted through the communication control section 22 (step 4000).

After the DHCP DISCOVER packet is transmitted, the home gateway device 10 waits until the DHCP server 13 transmits a DHCP OFFER packet (step 4001). Upon receipt of the DHCP OFFER packet from the DHCP server 13, the home gateway device 10 checks whether there is a problem with an IP address that is stored in the DHCP OFFER packet and assigned from the DHCP server 13 to the home gateway device 10 (checks, for instance, that the IP address is not used by another device) (step 4002). If there is no problem with the IP address assigned from the DHCP server 13, the home gateway device 10 creates a DHCP REQUEST packet and transmits it to the DHCP server 13 (step 4003).

Next, the home gateway device 10 waits to receive a DHCP ACK packet from the DHCP server 13 (step 4004). Upon receipt of the DHCP ACK packet, the home gateway device 10 uses the IP address assigned from the DHCP server 13 as its IP address (step 4005). In addition, the home gateway device 10 acquires and stores an encryption key that is attached to the DHCP ACK packet (step 4006).

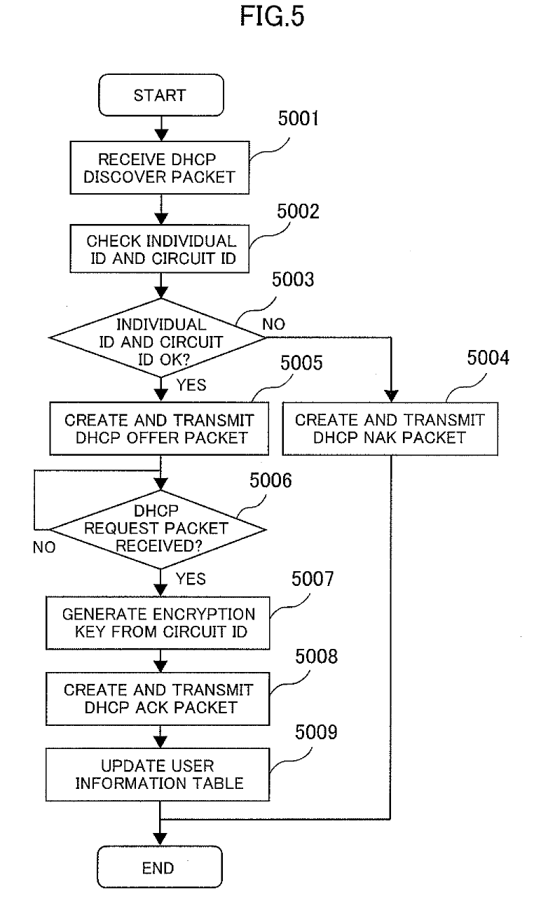

FIG. 5 is a flowchart illustrating a process in which the DHCP server 13 issues an IP address to the home gateway device 10. Obviously, this process is performed by a CPU that serves as the aforementioned processing section. First of all, the DHCP server 13 waits until the home gateway device 10 transmits a DHCP DISCOVER packet. Upon receipt of the DHCP DISCOVER packet from the home gateway device 10 (step 5001), the DHCP server 13 acquires the individual ID and circuit ID of the home gateway device 10 from the DHCP DISCOVER packet (step 5002). Next, the DHCP server 13 compares the acquired individual ID and circuit ID against the contents of a home gateway device information table stored in itself (step 5003), as described later. If the combination of the individual ID and circuit ID acquired from the DHCP DISCOVER packet is not registered in the table, which shows the individual ID-to-circuit ID correspondence, the DHCP server 13 concludes that unauthorized access is attempted, and then transmits a DHCP NAK packet to the home gateway device 10 (step 5004). Alternatively, the DHCP server 13 may simply discard the received packet and refrain from returning a response instead of transmitting the DHCP NAK packet.

If, on the other hand, the combination of the individual ID and circuit ID is registered in the home gateway device information table, the DHCP server 13 determines the IP address to be assigned to the home gateway device, creates a DHCP OFFER packet that designates the determined IP address, and transmits the created DHCP OFFER packet to the home gateway device 10 (step 5005).

Next, the DHCP server 13 waits to receive a DHCP REQUEST packet from the home gateway device 10 (step 5006). Upon receipt of the DHCP REQUEST packet from the home gateway device 10, the DHCP server 13 generates an encryption key from the circuit ID (step 5007). In this instance, a unique encryption key is temporarily generated from the circuit ID each time an IP address is assigned to the home gateway device 10.

Next, the DHCP server 13 creates a DHCP ACK packet and attaches the encryption key to the created DHCP ACK packet. The DHCP server 13 then sends to the home gateway device 10 the DHCP ACK packet to which the encryption key is attached.

Further, the DHCP server 13 updates the entry information in the home gateway device information table that is related to the home gateway device 10, and stores the IP address assigned to the home gateway device 10 and the created encryption key. The IP address to be assigned to a home gateway device may be predetermined for the individual ID of the home gateway device or selected from those available at the time of a request.

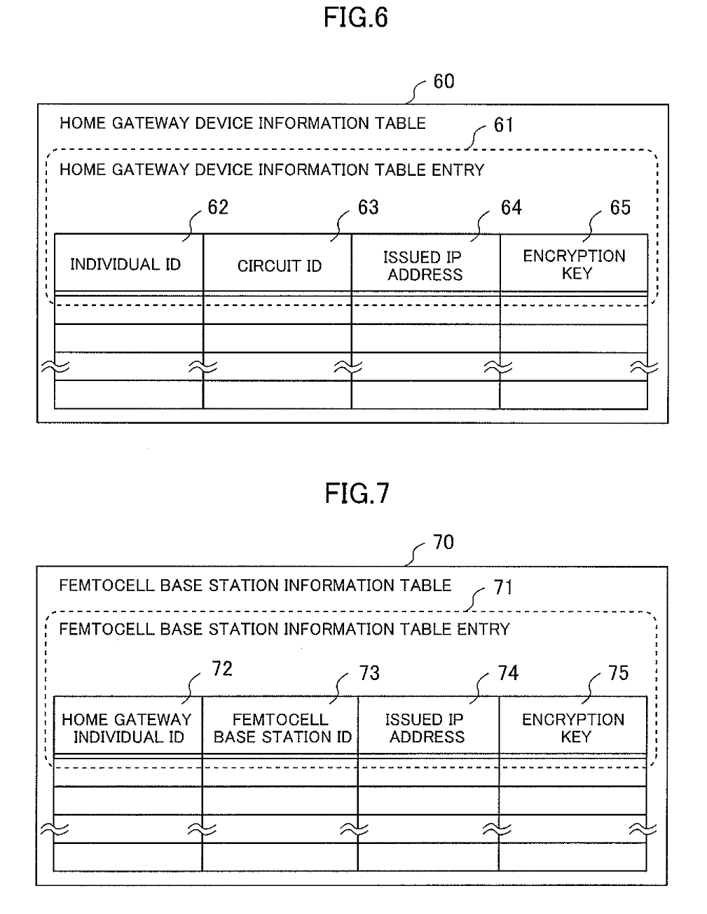

FIG. 6 is a diagram illustrating an exemplary configuration of the home gateway device information table 60 retained by the DHCP server 13. The home gateway device information table 60 is formed in the storage section of a normal server. The home gateway device information table 60 is composed of an aggregate of home gateway device information table entries 61. Each home gateway device information table entry 61 has a plurality of fields for storing actual data. An individual ID field 62 stores the individual ID of the home gateway device 10 delivered to a user.

A circuit ID field 63 stores the information about a circuit to which a home gateway device having the individual ID field 62 of the associated entry is connected. An issued IP address field 64 stores an IP address issued to the home gateway device 10 having the individual ID field 62 of the associated entry. An encryption key field 65 stores an encryption key created from the circuit ID of the associated entry.

FIG. 7 is a diagram illustrating an exemplary configuration of a femtocell base station information table 70 retained by the femtocell base station gateway 14. The femtocell base station information table 70 is also formed in the storage section included in a normal server. The femtocell base station information table 70 is composed of an aggregate of femtocell base station information table entries 71. Each femtocell base station information table entry 71 has a plurality of fields for storing actual data. A home gateway individual ID field 72 stores the individual ID of a home gateway device 10 in which a femtocell base station module is incorporated. A femtocell base station ID field 73 stores an identifier for identifying a femtocell base station. An issued IP address field 74 stores an IP address that is issued from the DHCP server 13 to a home gateway device 10 having a home gateway individual ID of the associated entry. An encryption key field 75 stores an encryption key that is generated from a circuit ID by the DHCP server 13.

The femtocell base station information table 70 is updated in accordance with information transmitted from the DHCP server 13. Such information transmission from the DHCP server 13 is triggered when the DHCP server 13 issues an IP address to the home gateway device 10 and creates an encryption key. It is assumed that a sufficiently secure communication path is established by means, for instance, of encryption for the communication between the femtocell base station gateway 14 and DHCP server 13.

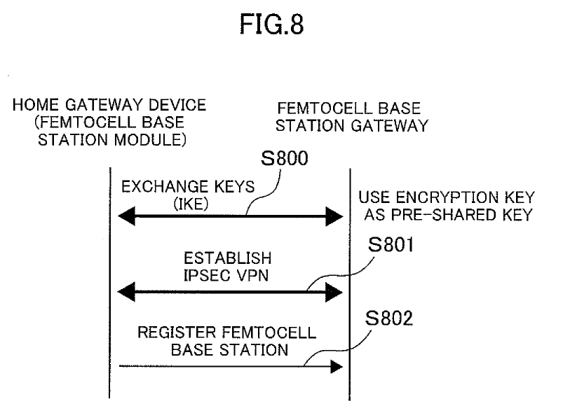

FIG. 8 is a sequence diagram illustrating how the femtocell base station module 23, which is incorporated in the home gateway device 10, registers itself at the femtocell base station gateway 14. An operation performed on the femtocell base station gateway will not be described in detail, but is controlled by a CPU that serves as the aforementioned processing section.

When an IP address is assigned to the home gateway device 10, the femtocell base station control section 25 of the femtocell base station module 23 incorporated in the home gateway device 10 establishes a session with the femtocell base station gateway 14 by using the IP address of the femtocell base station gateway 14, which is preselected in the femtocell base station module 23. First of all, the encryption key received from the DHCP server 13 is used as a pre-shared key to exchange keys by means of IKE (Internet Key Exchange) (step S800). The obtained key is then used to establish an IPSec VPN (IP Security Virtual Private Network) (step S801). The femtocell base station module 23 uses the established IPSec VPN to make a registration at the femtocell base station gateway 14. At the time of registration, the individual ID of the home gateway device 10 in which the femtocell base station module 23 is incorporated is additionally transmitted.

The pre-shared key used for IKE is generated in the DHCP server 13 by using the circuit ID of the home gateway device 10. When a session is established between the femtocell base station module 23 and femtocell base station gateway 14, it means that the femtocell base station module 23 is connected from a correct circuit. This makes it possible to reject an access attempt through an illegal circuit.

Further, when the individual ID of the home gateway device 10 and the ID of the femtocell base station module 23 are managed as a pair as indicated in the femtocell base station information table 70 retained by the femtocell base station gateway 14, it is possible to prevent an authorized femtocell base station module from being connected to an irrelevant authorized home gateway device and used.

The present embodiment assumes that the address of the femtocell base station gateway 14 is preset in the home gateway device 10. However, when the DHCP server 13 assigns an IP address to the home gateway device 10, the DHCP server 13 may alternatively attach, for instance, the address of the femtocell base station gateway 14 as well as the encryption key to the DHCP ACK packet and allow the femtocell base station module 23 in the home gateway device 10 to use that address to register itself at the femtocell base station gateway 14.

When the DHCP server 13 issues an IP address to the home gateway device 10, the first embodiment, which has been described above, attaches the encryption key generated from a circuit ID to the IP address. Consequently, when the femtocell base station module 23 in the home gateway device 10 establishes communication with the femtocell base station gateway 14, it is possible to not only obtain a secure communication path, but also verify that the femtocell base station module 23 is accessing through an authorized circuit.

### Second Embodiment

A second embodiment of the present invention will now be described. The second embodiment will be described by explaining about communication path establishment between a femtocell base station device and a femtocell base station gateway in a situation where the home gateway device and femtocell base station device are implemented as different devices.

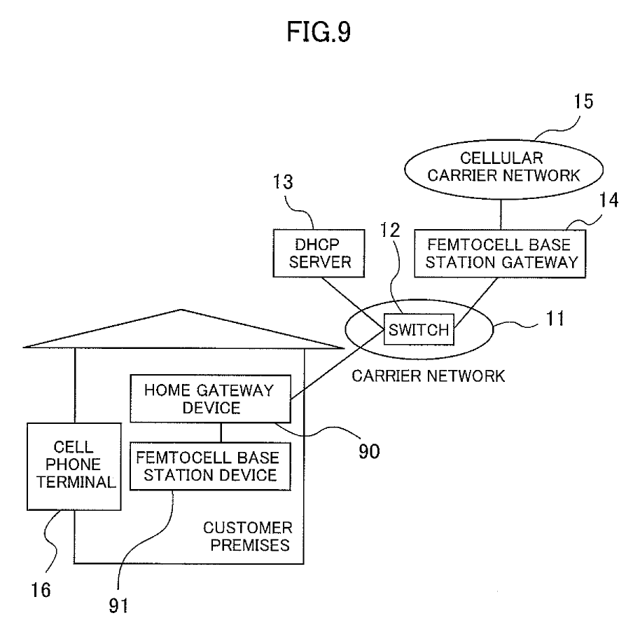

FIG. 9 is a diagram illustrating the configuration of a system according to the second embodiment. The system configuration according to the second embodiment differs from the one according to the first embodiment. In the first embodiment, the femtocell base station module is integrated into the home gateway device. In the second embodiment, on the other hand, a femtocell base station device 91 is implemented as a device different from a home gateway device 90 and connected to the home gateway device 90. The other devices are configured the same as their counterparts in FIG. 1 and identified by the same reference numerals as in FIG. 1.

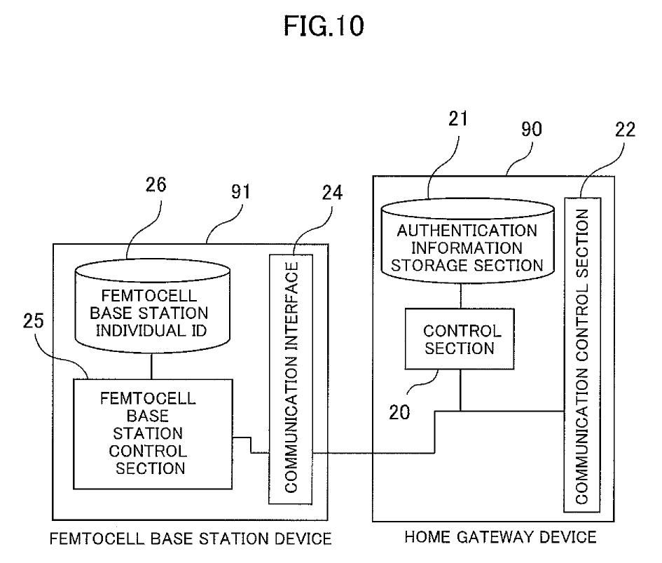

FIG. 10 is a diagram illustrating an exemplary configuration of the home gateway device 90 and femtocell base station device 91 according to the second embodiment. The home gateway device 91 includes a communication control section 22 for communicating with a customer-premises network and carrier network. Packets received by the home gateway device 91 are processed by the communication control section 22 and transferred as needed to the other devices. Packets requiring further processing are transmitted to a control section 20 and processed in the control section 20. An authentication information storage section 21 stores the individual ID of the home gateway device 90 and other information necessary for the DHCP server 13 to authenticate the home gateway device 90. When the home gateway device 90 requests the DHCP server 13 to issue an IP address, the information stored in the authentication information storage section 21 is read, attached to a request packet, and transmitted.

The femtocell base station device 91 includes a communication interface 24 for communicating with the home gateway device 90. The femtocell base station device 91 communicates with the home gateway device 90 and an external network through the communication interface 24. The femtocell base station device 91 is controlled by a femtocell base station control section 25. Obviously, this control section 25 is also composed of a CPU, which is a common central processing unit. A femtocell base station individual ID storage section 26 is a storage device for storing an individual ID that is used to register the femtocell base station device 91 at a femtocell base station gateway 14. The stored individual ID is set to a fixed value prior to shipment and cannot be read or rewritten as desired by a user.

The DHCP server 13 assigns an IP address to the home gateway device 90 in the same manner as in the first embodiment. More specifically, the DHCP server 13 assigns an IP address to the home gateway device 90 when the home gateway device 90 starts up. In this instance, the home gateway device 90 receives from the DHCP server 13 an encryption key that the DHCP server 13 generated by using a circuit ID. The received encryption key is then stored in the home gateway device 90.

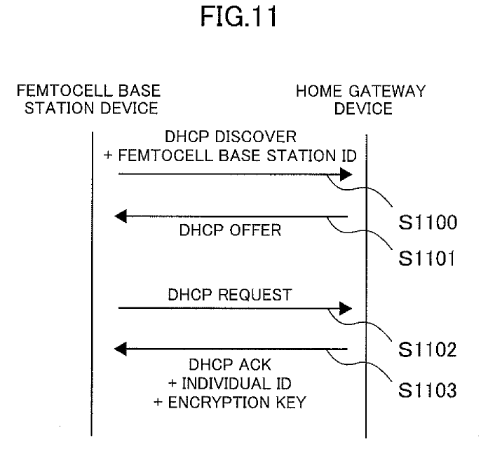

FIG. 11 is a sequence diagram illustrating a process that is performed when the home gateway device 90 assigns an IP address to the femtocell base station device 91. When the femtocell base station device 91 starts up, it transmits a DHCP DISCOVER packet to acquire an IP address (step S1100). In this instance, the femtocell base station device 91 transmits the DHCP DISCOVER packet with a femtocell base station ID attached to it. Upon receipt of the DHCP DISCOVER packet, the home gateway device 90 determines the IP address to be assigned to the femtocell base station device 91, places the IP address in a DHCP OFFER packet, and transmits the DHCP OFFER packet to the femtocell base station device 91 (step S1101).

Upon receipt of the DHCP OFFER packet, the femtocell base station device 91 acquires the IP address, which is designated by the DHCP server 13, from the DHCP OFFER packet. The femtocell base station device 91 then checks whether the acquired IP address is usable. If the check shows no problem, the femtocell base station device 91 creates a DHCP REQUEST packet and transmits it to the home gateway device 90 (step S1102).

Upon receipt of the DHCP REQUEST packet, the home gateway device 90 creates a DHCP ACK packet and sends it to the femtocell base station device 91 (step S1103). In this instance, the individual ID of the home gateway device 90 and the encryption key transmitted from the DHCP server 13 are attached to the DHCP ACK packet created by the home gateway device 90.

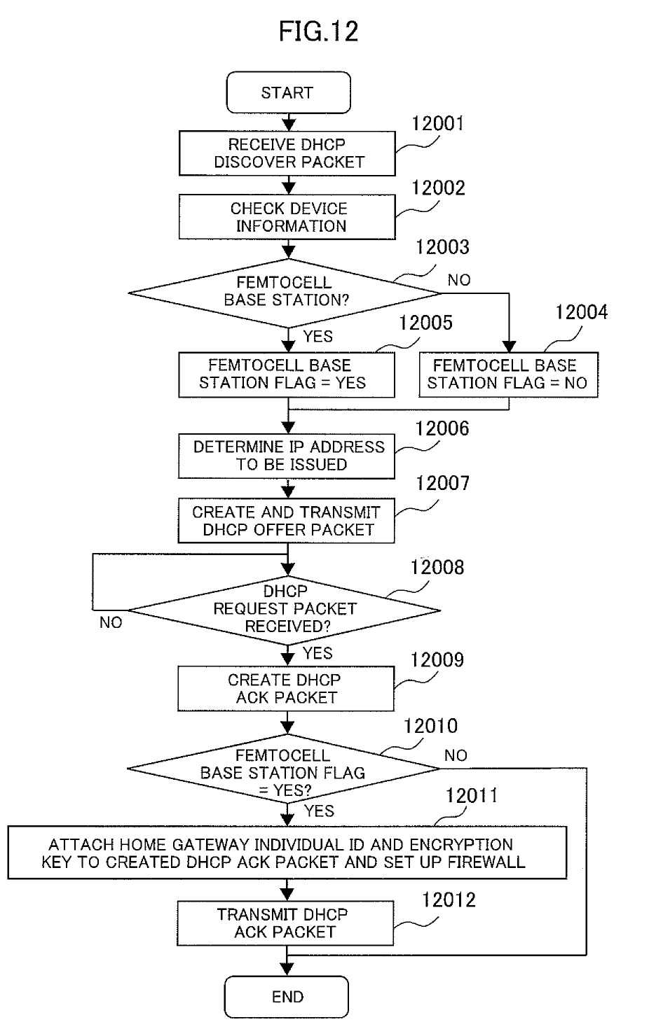

FIG. 12 is a flowchart illustrating how the home gateway device 90 operates when it issues an IP address to the femtocell base station device 91. First of all, the home gateway device 90 waits until the femtocell base station device 91 transmits a DHCP DISCOVER packet. Upon receipt of the DHCP DISCOVER packet from the femtocell base station device 91 (step 12001), the home gateway device 90 obtains device information from the DHCP DISCOVER packet (step 12002), and uses the obtained device information to identify a device that requested an IP address (step 12003).

If the IP address requesting device is not a femtocell base station device, the home gateway device 90 proceeds to perform an IP address issuance procedure without setting a flag that is stored in the home gateway device 90 to indicate whether the IP address requesting device is a femtocell base station (step 12004). If, on the other hand, the IP address requesting device is a femtocell base station device, the home gateway device 90 sets the flag that is stored in the home gateway device 90 to indicate whether the IP address requesting device is a femtocell base station (step 12005), and then determines the IP address to be assigned to the IP address requesting device (step 12006). The IP address to be assigned to the IP address requesting device may be predetermined for each device to be connected or selected from those available at the time of an IP address request.

After determining the IP address to be assigned to the IP address requesting device, the home gateway device 90 creates a DHCP OFFER packet, transmits it to the IP address requesting device (step 12007), and then waits until the IP address requesting device transmits a DHCP REQUEST packet (step 12008). Upon receipt of the DHCP REQUEST packet, the home gateway device 90 creates a DHCP ACK packet (step 12009). If, in this instance, a flag is set to indicate whether the IP address requesting device is the femtocell base station device 91, the home gateway device 90 attaches to the created DHCP ACK packet the individual ID of the home gateway device 90 and the encryption key that is transmitted from the DHCP server 13 and used to establish communication with the femtocell base station gateway 14. In addition, the home gateway device 90 updates settings, such a firewall setting, to ensure that packets can be exchanged between the femtocell base station device 91 and the femtocell base station gateway 14 via the home gateway device 90 (step 12011). Next, the home gateway device 90 transmits a DHCP ACK packet to which the individual ID of the home gateway device 90 and the encryption key are attached.

If, on the other hand, the flag is not set to indicate whether the IP address requesting device is a femtocell base station device, the home gateway device 90 merely sends the DHCP ACK packet.

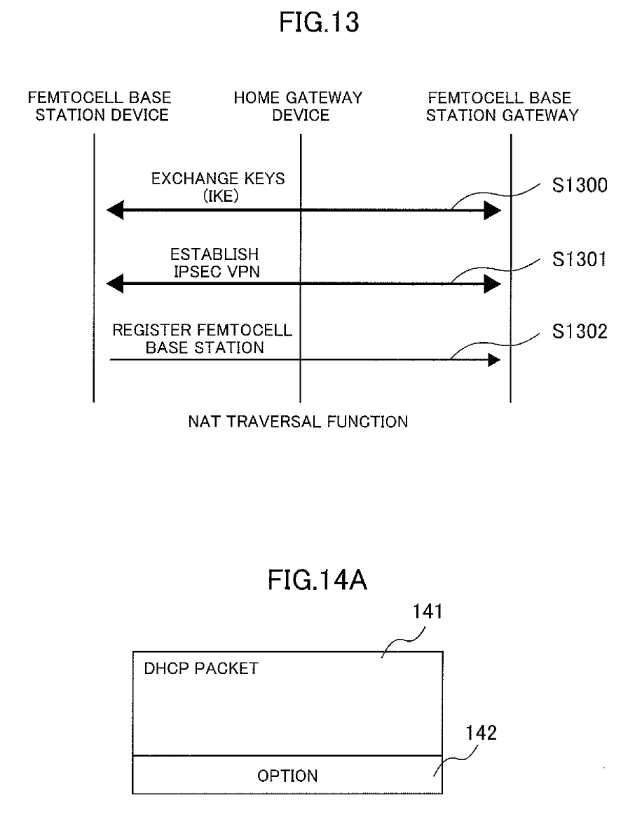

FIG. 13 is a sequence diagram illustrating how the femtocell base station device 91 registers itself at the femtocell base station gateway 14. Here, an NAT (Network Address Translator) traversal function is incorporated into the home gateway device 90 so as to establish IPSec VPN between the femtocell base station device 91 and the femtocell base station gateway 14. Therefore, the NAT traversal function is set up for packets exchanged between the femtocell base station device 91 and the femtocell base station gateway 14 when the home gateway device 90 issues an IP address to the femtocell base station device 91.

When the IP address is assigned to the femtocell base station device 91, the femtocell base station control section 25 of the femtocell base station device 91 establishes a session with the femtocell base station gateway by using the IP address of the femtocell base station gateway, which is preset in the femtocell base station device 91. First of all, the encryption key received from the DHCP server 13 is used as a pre-shared key to exchange keys by means of IKE (Internet Key Exchange) (step S1300). The obtained key is then used to establish an IPSec VPN (step S1301). The femtocell base station device 91 uses the established IPSec VPN to make a registration at the femtocell base station gateway 14. At the time of registration, the individual ID of the home gateway device 10, which was received when the IP address was issued from the home gateway device 90, is additionally transmitted.

The pre-shared key used for IKE is generated by the DHCP server 13 by using the circuit ID of the home gateway device 90. When a session is established between the femtocell base station device 91 and femtocell base station gateway 14, it means that the femtocell base station device 91 is connected from a correct circuit. This makes it possible to reject an access attempt through an illegal circuit.

Further, when the individual ID of the home gateway device 90 and the ID of the femtocell base station device 91 are managed as a pair, as is the case with the foregoing embodiment, it is possible to prevent an authorized femtocell base station device 91 from being connected to an irrelevant authorized home gateway device and used.

The present embodiment assumes that the address of the femtocell base station gateway 14 is preset in the home gateway device 90. However, when the DHCP server 13 assigns an IP address to the home gateway device 90, the DHCP server 13 may alternatively attach, for instance, the IP address of the femtocell base station gateway 14 as well as the encryption key to the DHCP ACK packet, and attach the IP address to a packet that the home gateway device 90 uses to assign the IP address to the femtocell base station device 91, thereby dynamically sending the IP address of the femtocell base station gateway 14 to the femtocell base station device 91. When the femtocell base station device uses that IP address to register itself at the femtocell base station gateway, it is possible to save the trouble of presetting the femtocell base station device's IP address in the femtocell base station device.

When the DHCP server issues an IP address to the home gateway device, as is the case with the first embodiment, even in a situation where the femtocell base station device is implemented as a device different from a home gateway, the second embodiment, which has been described above, attaches the encryption key generated from a circuit ID to the IP address, sends the encryption key to the femtocell base station device through the home gateway device, and allows the DHCP server device to send the encryption key to the femtocell base station gateway. Consequently, when the femtocell base station device establishes communication with the femtocell base station gateway, it is possible to not only obtain a secure communication path, but also verify that the femtocell base station module is accessing through an authorized circuit.

The present invention, which has been described in detail above, makes it possible to not only automatically exchange keys as needed to establish a secure communication path between application servers such as a femtocell base station device and a femtocell base station gateway, but also guarantee that the femtocell base station device is connected from an authorized location.

As being described above in detail, it is clear that the present invention is not restricted to the invention defined in claims. The present invention disclosed in the specification also includes the followings.

A network system comprising:

a network;

a DHCP server device;

a DHCP client device;

an application server device; and

a communication device that uses the DHCP client device as a gateway to connect to the network;

wherein the DHCP server device includes a storage section for storing individual identification information about the DHCP client device and connection path information about the connection of the DHCP client device, compares individual identification information and DHCP client device connection path information received from the DHCP client device against the information stored in the storage section when issuing an IP address to the DHCP client device, transmits the IP address and an identifier generated from the connection path information to the DHCP client device only when the compared items of information match, and transmits the identifier and the individual identification information about the DHCP client device to the application server device;

wherein the DHCP client device checks identification information about the communication device when the issuance of the IP address is requested by the communication device, issues the IP address with the identifier and individual identification information about the DHCP client device attached to the IP address when the identification information about the communication device indicates that the identifier and individual identification information about the DHCP client device need to be transmitted, and transmits the identifier and individual identification information about the DHCP client device to the application server device when the communication device establishes a communication path to the application server device; and

wherein the application server device compares the identifier and DHCP client device individual identification information transmitted from the DHCP client device against the identifier and DHCP client device individual identification information transmitted from the DHCP server device, and establishes a communication path to the communication device only when the compared items of information match.

The above network system,

wherein the communication device is a femtocell base station device;
wherein the DHCP client device is a gateway; and wherein the application server device is a femtocell base station gateway.

The above network system, wherein the identifier is used as an encryption key for establishing a communication path between the DHCP client device and the application server device.

The above network system, wherein the identifier is used as an IKE pre-shared key for establishing a communication path between the DHCP client device and the application server device.

The above network system, wherein the communication path between the DHCP client device and the application server device is established by an IPSec VPN.

A DHCP client device connected to a DHCP server device through a network, the DHCP client device comprising:

a processing section; and

a storage section;

wherein the storage section stores an identifier that is generated from the connection path information about the DHCP client device and transmitted when the DHCP server device issues an IP address to the DHCP client device; and

wherein the processing section checks identification information about a femtocell base station device when the issuance of an IP address is requested by the femtocell base station device that connects to the network by using the DHCP client device as a gateway, issues the IP address with the identifier and individual identification information about the DHCP client device attached to the IP address when the identification information about the femtocell base station device indicates that the identifier and individual identification information about the DHCP client device need to be transmitted, and establishes a communication path by using the identifier stored in the storage section when connecting the femtocell base station device to a femtocell base station gateway on the network.

What is claimed is:

1. A network system, comprising:
a network;
a DHCP (Dynamic Host Configuration Protocol) server device;
a DHCP client device; and
an application server device;
the DHCP server device, the DHCP client device, and the application server device being connected through the network;
wherein the DHCP server device includes a storage section for storing individual identification information about the DHCP client device and connection path information about the connection of the DHCP client device as a pair, compares individual identification information and DHCP client device connection path information received from the DHCP client device against the information stored in the storage section when issuing an IP (Internet Protocol) address to the DHCP client device, transmits the IP address and an identifier generated from the connection path information to the DHCP client device only when the compared items of information match, and transmits the identifier and the individual identification information about the DHCP client device to the application server device;
wherein the DHCP client device transmits the identifier and individual identification information received from the DHCP server device to the application server device when establishing a communication path to the application server device; and
wherein the application server device compares the identifier and individual identification information transmitted from the DHCP client device against the identifier and individual identification information transmitted from the DHCP server device, and establishes the communication path to the DHCP client device only when the compared items of information match.

2. The network system according to claim 1, wherein the identifier is used as an encryption key for establishing a communication path between the DHCP client device and the application server device.

3. The network system according to claim 1, wherein the identifier is used as an IKE (Internet Key Exchange) pre-shared key for establishing a communication path between the DHCP client device and the application server device.

4. The network system according to claim 3, wherein the communication path between the DHCP client device and the application server device is established by an IPSec VPN (IP Security Virtual Private Network).

5. The network system according to claim 1, wherein the DHCP client device is a gateway with a built-in femtocell base station module; and wherein the application server device is a femtocell base station gateway.

6. A DHCP server device connected to a DHCP client device through a network, the DHCP server device comprising:
a storage section for storing individual identification information about the DHCP client device and connection path information about the connection of the DHCP client device as a pair; and
a processing section;
wherein the processing section compares individual identification information and DHCP client device connection path information received from the DHCP client device against the information stored in the storage section when issuing an IP address to the DHCP client device, issues the IP address to the DHCP client device only when the compared items of information match, transmits an identifier generated from the connection path information about the DHCP client device to the DHCP client device, and transmits the identifier and the individual identification information about the DHCP client device to an application server device.

7. The DHCP server device according to claim 6, wherein the storage section includes a table containing the individual identification information about the DHCP client device, the connection path information about the connection of the DHCP client device, the IP address issued to the DHCP client device, and the identifier transmitted to the DHCP client device.

8. A DHCP client device connected to a DHCP server device through a network, the DHCP client device comprising:
a processing section; and
a storage section;
wherein the storage section stores an identifier that is generated from the connection path information about the DHCP client device and transmitted when the DHCP server device issues an IP address to the DHCP client device; and
wherein the processing section establishes a connection path by using the identifier stored in the storage section when connecting to an application server device on the network.

9. The DHCP client device according to claim 8, wherein the application server device is a femtocell base station gateway and functions as a gateway with a built-in femtocell base station module.
